(19) United States
(12) Patent Application Publication
(10) Pub. No.: US 2005/0281974 A1
(43) Pub. Date: Dec. 22, 2005

(54) Thermo bonding film structure

(76) Inventor: Wen-Chang Lu, Taipei Hsien (TW)

Correspondence Address: Wen-Chang Lu, 7F., NO. 213, CIVIC BOULEVARD. SEC. 4, TAIPEI, 105, TW

(21) Appl. No.: 10/871,414

(22) Filed: Jun. 18, 2004

(51) Int. Cl. B32B 9/00

(52) U.S. Cl. 428/40.1

(57) ABSTRACT

Disclosed is an improved thermo bonding film structure, comprising: a heat-sensitive adhesive layer provided to at least a face of the thermo bonding film; and a removable substrate provided to another face of the thermo bonding film, such that the thermo bonding film may be repeatedly positioned and adhered to objects prior to being thermally cured to prevent displacement of the thermo bonding film in the process of thermally bonding two objects, thereby ensuring the thermo bonding film to be adhered to proper locations of the two objects.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to a thermo bonding film structure, particularly to an improved thermo bonding film structure that may be repeatedly positioned and adhered to objects prior to being thermally cured to prevent displacement of the thermo bonding film in the process of thermally bonding two objects, thereby ensuring the thermo bonding film to be adhered to proper locations of the two objects.

### BACKGROUND

Due to the rapid time transition and the acquirement of fashion information, the youngsters prefer to create objects that are of personal styles, such as variations made to clothing or ornaments, to exhibit one's taste. One of the most significant examples is to sew various patterns to a garment. Sewing, however, is not suitable to everyone and thus thermo bonding films have become available in the market to serve as a bonding medium, whereby patterns, fabrics or other objects may then be rapidly adhered and bonded to the garment upon applying an iron or heat seal machine to the thermo bonding films.

FIGS. 1 to 4 show the first to the fourth illustrations of the state of use for the conventional thermo bonding films. As shown, a thermo bonding film 1 is applied on a face thereof of a removable release layer 11 and is intended to be applied to a garment for adhering and bonding to another fabric 21 that later serves a pocket of the garment 2. In the conventional measure, the thermo bonding film 1 that has been properly trimmed is applied to the garment 2 at a location that corresponds to where the fabric 21 intends to be placed. After the thermo bonding film 1 has been placed on the garment 2 at the designated location, a heat seal machine 3 (or an iron) is then implemented to perform a first heat pressing process. After the thermo bonding film 1 has been adhered and bonded to the garment 2, the release layer applied to the face thereof is then removed therefrom. The fabric 21 is then placed over the thermo bonding film 1. The heat seal machine 3 (or iron) is then implemented to perform a second heat pressing process, thereby allowing quick making of a pocket without sewing.

Though the conventional thermo bonding film 1 may be rapidly and easily bonded to objects by heat pressing, if in the process of heat pressing by the heat seal machine 3, any stretching or other factors may result in displacement of the thermo bonding film 1 (during the first heat pressing process) or the fabric 21 (during the second heat pressing process), whereby the fabric 21 is applied to the fabric is a disagreeable manner (such as the garment and fabric after being subject to heat pressing garment shown in FIG. 5). Hence, it would be essential to affix the thermo bonding film 1 or fabric 21 prior to heat pressing in order to resolve such a problem.

### SUMMARY OF INVENTION

In view of the disadvantages of the conventional thermo bonding film structure, the invention provides an improved thermo bonding film structure that may be repeatedly positioned and adhered to objects prior to being thermally cured to prevent displacement of the thermo bonding film in the process of thermally bonding two objects, thereby ensuring the thermo bonding film to be adhered to proper locations of the two objects.

It is thus a primary objective of this invention to provide an improved thermo bonding film structure that may be repeatedly positioned and adhered to objects prior to being thermally cured to prevent displacement of the thermo bonding film in the process of thermally bonding two objects, thereby ensuring the thermo bonding film to be adhered to proper locations of the two objects.

It is another objective of this invention to provide an improved thermo bonding film structure that may be adhered and bonded to the proper locations to two objects by a single heat pressing process.

To achieve the above objectives, this invention discloses an improved thermo bonding film structure, comprising: a heat-sensitive adhesive layer provided to at least a face of the thermo bonding film; and a removable substrate provided to another face of the thermo bonding film, such that the thermo bonding film may be repeatedly positioned and adhered to objects prior to being thermally cured to prevent displacement of the thermo bonding film in the process of thermally bonding two objects, thereby ensuring the thermo bonding film to be adhered to proper locations of the two objects.

### BRIEF DESCRIPTION OF THE DRAWINGS

These and other modifications and advantages will become even more apparent from the following detailed description of a preferred embodiment of the invention and from the drawings in which:

FIG. 1 is a first illustration showing the state of use of the conventional thermo bonding film.

FIG. 2 is a second illustration showing the state of use of the conventional thermo bonding film.

FIG. 3 is a third illustration showing the state of use of the conventional thermo bonding film.

FIG. 4 is a fourth illustration showing the state of use of the conventional thermo bonding film.

FIG. 5 is a schematic drawing showing a garment and a fabric that has been subject to the conventional heat pressing processes.

FIG. 6 is a schematic drawing illustrating a first embodiment of this invention.

FIG. 7 is a schematic drawing illustrating a second embodiment of this invention.

FIG. 8 is a cross-sectional view of the thermo bonding film of this invention.

FIG. 9 illustrates a preferred embodiment of this invention.

FIG. 10 is a first illustration showing the state of use of the embodiment in FIG. 9.

FIG. 11 is a second illustration showing the state of use of the embodiment in FIG. 9.

FIG. 12 is a third illustration showing the state of use of the embodiment in FIG. 9.

FIG. 13 is a schematic drawing showing a garment and a fabric that has been subject to the heat pressing processes according to this invention.

FIG. 14 is a schematic drawing showing a first embodiment of the transfer printing according to this invention.

FIG. 15 is a schematic drawing showing a second embodiment of the transfer printing according to this invention.

FIG. 16 is a cross-sectional view of an alternative embodiment of the thermo bonding film of this invention.

FIG. 17 is a cross-sectional view of a further embodiment of the thermo bonding film of this invention.

FIG. 18 illustrates the state of use of the embodiment in FIG. 17.

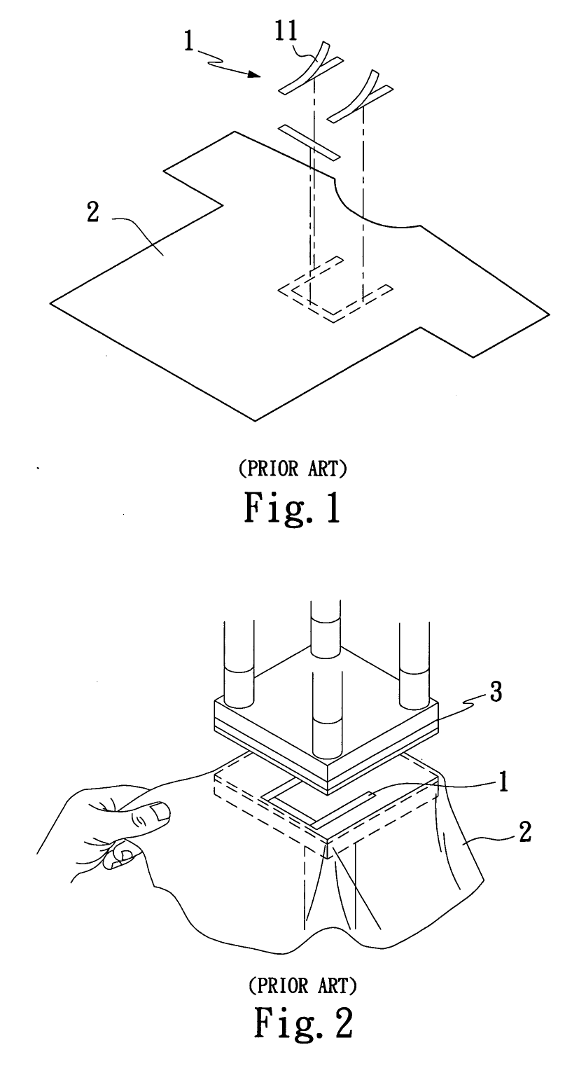

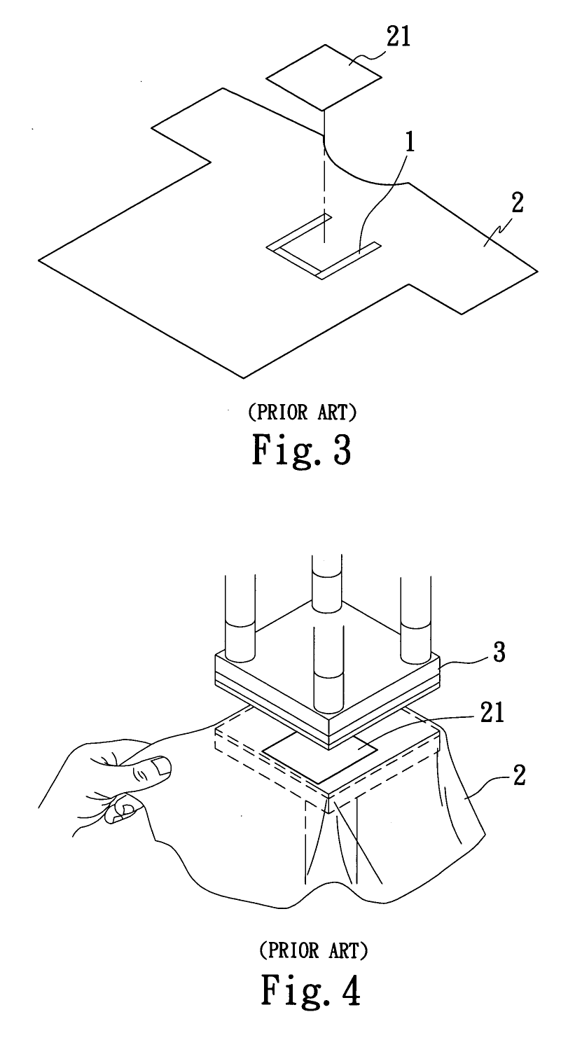

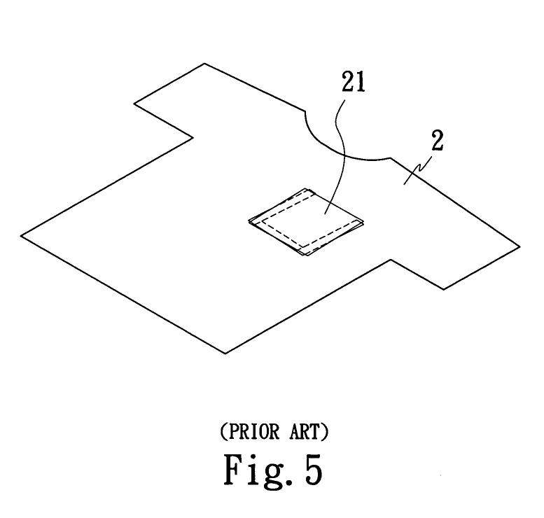

### DETAILED DESCRIPTION OF THE INVENTION (PREFERRED EMBODIMENTS)

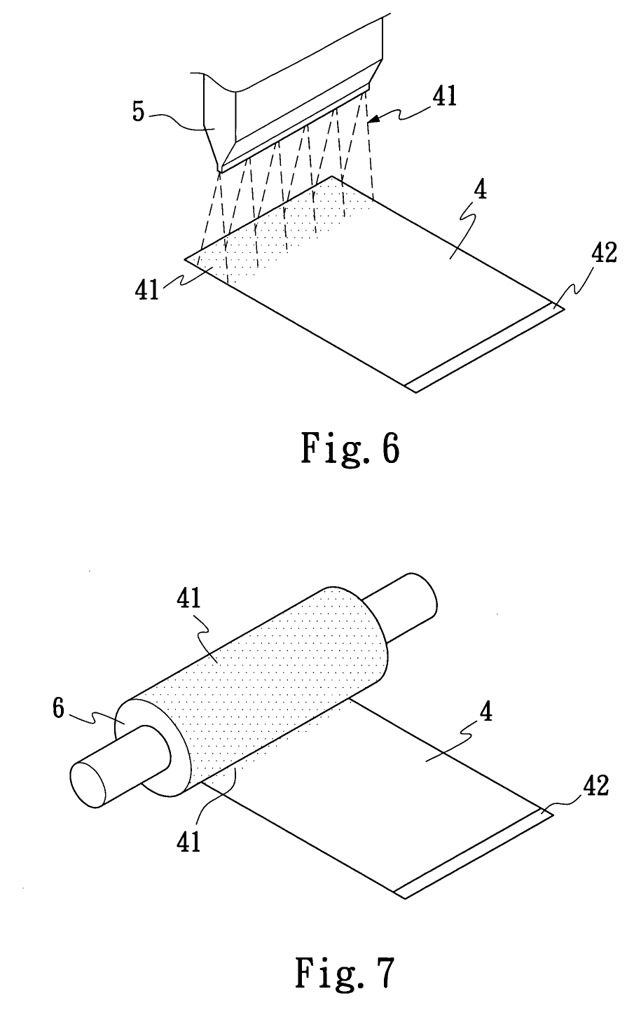

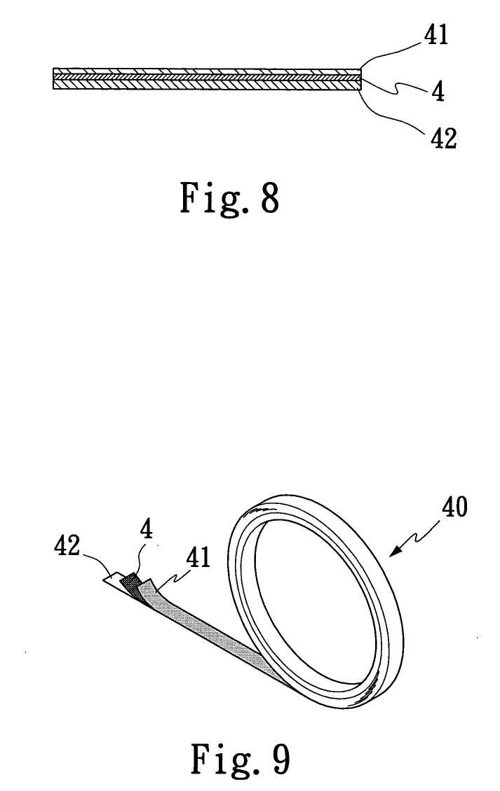

FIGS. 6 and 8 illustrate the cross-sectional views of the two embodiments for the thermo bonding films according to this invention. As shown, heat-sensitive adhesive 41 may be sprayed over or applied to a face of a thermo bonding film 4 by a nozzle 5 or a roller 6. A removable substrate is applied to another face of the thermo bonding film, wherein the substrate may be a release layer, a polyethylene (PE) layer or a polyethylene terephthalate (PET) layer, such that the thermo bonding film 4 is applied at a front and a back side thereof with the heat-sensitive adhesive 41 and substrate 42, respectively. Thusly, the thermo bonding film 4 may be wound into a roll 40 of thermo bonding film, with the substrate 42 being located at an exterior of the roll 40 of thermo bonding film (as shown by the preferred embodiment in FIG. 9).

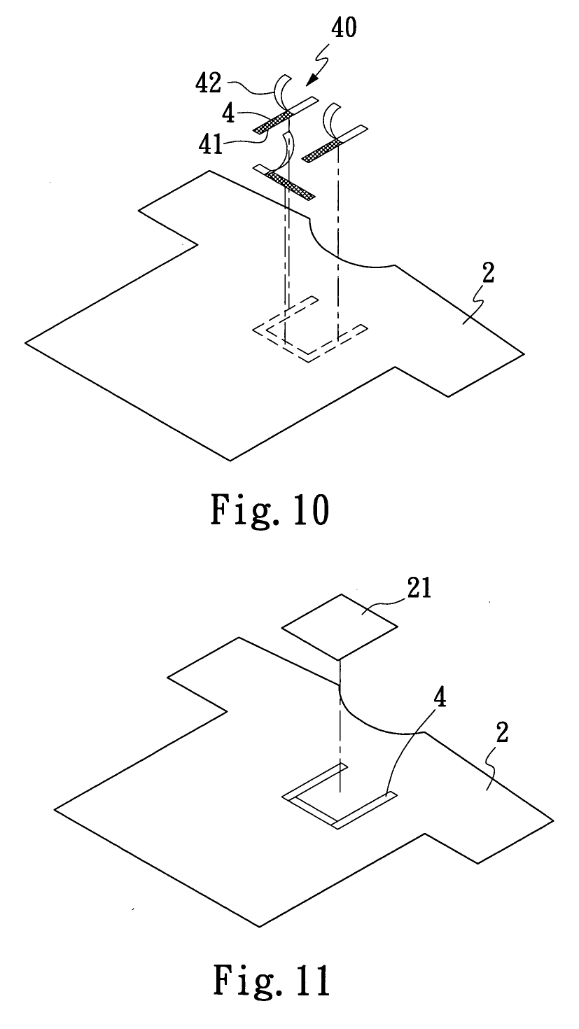

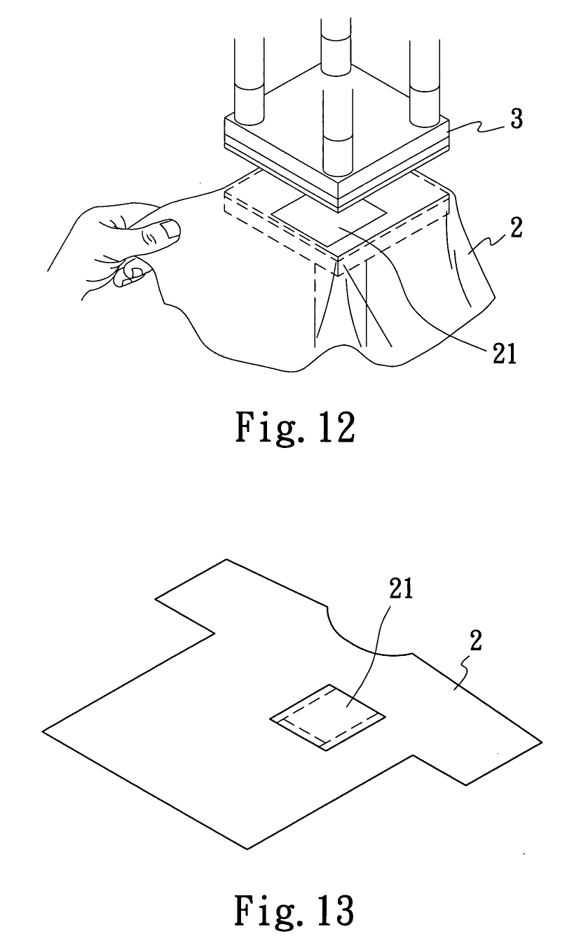

FIGS. 10 to 12 show the first to the third illustrations of the state of use for the thermo bonding films of this invention. As shown, after a location that a fabric 21 intended to be applied to a garment 2 has been designated, a thermo bonding film 4 that has been trimmed to a proper dimension is then directly adhered to the designated location by means of the heat-sensitive adhesive 41. Even if the thermo bonding film 4 is skewed upon being adhered to the garment 2, the thermo bonding film 4 may be removed and re-adhered to the fabric 2. After the thermo bonding film 4 has been adhered to the designated location, the substrate 42 is then removed and the fabric 21 is placed over the location corresponding to the thermo bonding film 4. A heat seal machine 3 (or an iron) is then implemented to perform a heat pressing process for adhering and bonding the fabric 21 to the garment 2 to an accurate location (as shown by the garment and fabric that has been subject to the heat pressing process according to this invention) to form an integral unit, thereby allowing quick making of a pocket. According to this invention, only a single heat pressing process is required by the heat seal machine 3 so as to significantly reduce the lead time. Furthermore, due to the repeatable applicable of the heat-sensitive adhesive 41, this invention also significantly reduces the failure rate of the final products.

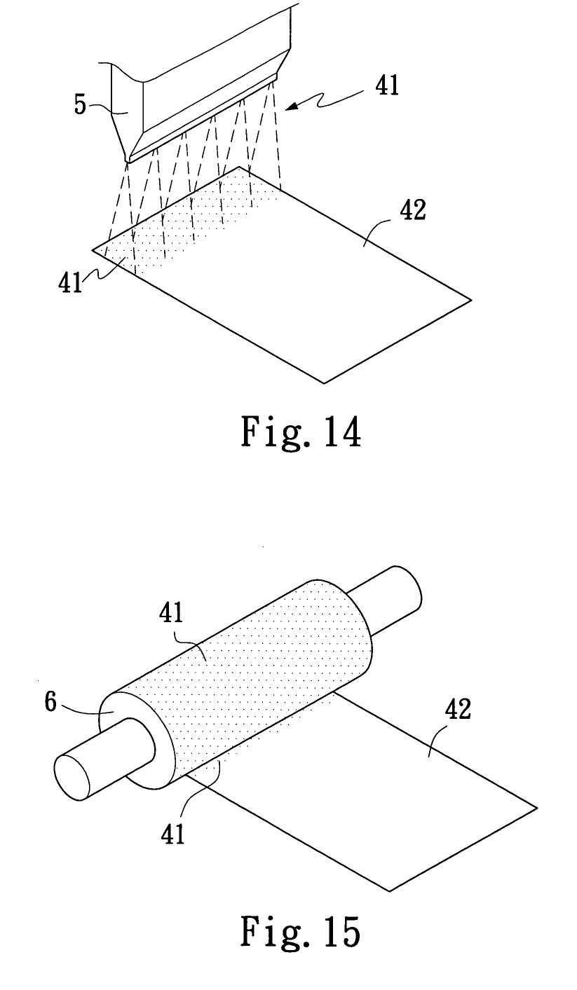

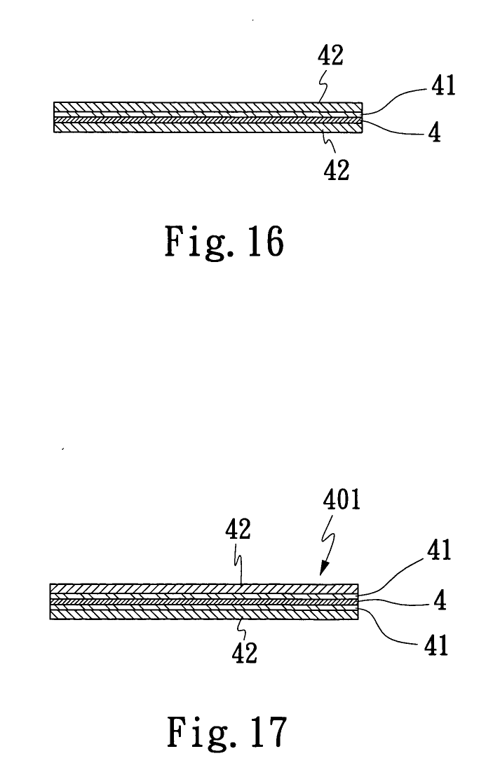

FIGS. 14 and 15 are schematic drawings showing a first and a second embodiment of the transfer printing according to this invention. As shown, the heat-sensitive adhesive 41 may be directly sprayed over or applied to the substrate 42 by a nozzle 5 or a roller 6. A face of the substrate 42 having the heat-sensitive adhesive 41 is then adhered to the thermo bonding film 4 for transferring the heat-sensitive adhesive 41 to the thermo bonding film 4. Another face of the thermo bonding film 4 is directly applied with a substrate 42 (such as the cross-sectional view as shown in FIG. 16). Alternatively, the faces of two substrates 42 that have heat-sensitive adhesive 41 are each transfer printed to the opposing faces of the thermo bonding film 4 for transferring the heat-sensitive adhesive 41 to the thermo bonding film 4, so as to obtain a twin-adhesive thermo bonding film 401 (such as the cross-sectional view as shown in FIG. 17). Such a twin-adhesive thermo bonding film 401 ensures accurate positioning in the subsequently heat pressing process.

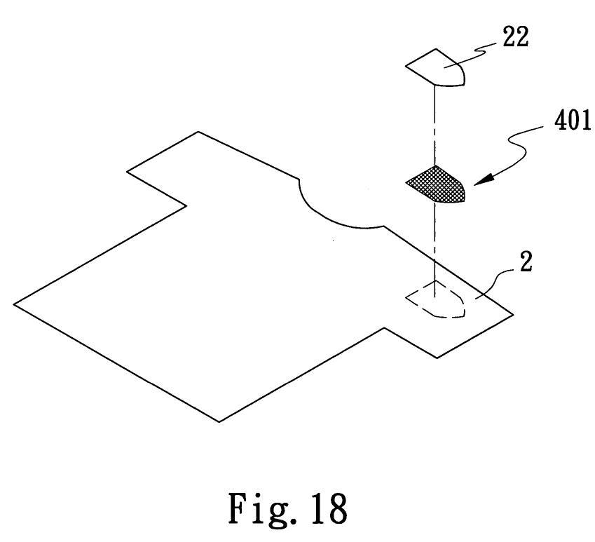

FIG. 18 illustrates the state of use of the embodiment in FIG. 17. As shown, a substrate 42 that is applied to one of the faces of the thermo bonding film 401 is first removed. The revealed heat-sensitive adhesive 41 of the thermo bonding film 401 is then directly applied to the garment 2 or a fabric 22 (that may featured with a pattern or a label). After the thermo bonding film 401 has been applied to a proper location, another substrate 42 that is applied to another face of the thermo bonding film 401 is removed. The revealed heat-sensitive adhesive 41 is then applied to the other of the fabric 22 or garment 2. A heat seal machine 3 (or an iron) is then implemented to perform a heat pressing process for adhering and bonding the fabric 22 to the garment 2 to an accurate location to form an integral unit, to allow rapid heat pressing. According to this invention, only a single heat pressing process is required by the heat seal machine 3 so as to significantly reduce the lead time. Furthermore, due to the repeatable applicable of the heat-sensitive adhesive 41 applied to both faces of the thermo bonding film 401, this invention also significantly reduce the failure rate of the final products.

As such, the thermo bonding film 4 may be repeatedly positioned and adhered to objects prior to being thermally cured to prevent displacement of the thermo bonding film in the process of thermally bonding two objects, thereby ensuring the thermo bonding film to be adhered to proper locations of the two objects.

1. An improved thermo bonding film structure, comprising:
a heat-sensitive adhesive layer provided to at least a face of the thermo bonding film; and
a removable substrate provided to another face of the thermo bonding film.

2. The improved thermo bonding film structure of claim 1, wherein the heat-sensitive adhesive layer is provided to a face of the thermo bonding film, the heat sensitive adhesive being applied with a (second) removable substrate; and the removable substrate is provided to another face of the thermo bonding film.

3. The improved thermo bonding film structure of claim 1, wherein the heat-sensitive adhesive layer is provided to a face of the thermo bonding film, the heat sensitive adhesive being applied with a (second) removable substrate; and the thermo bonding film is provided to another face thereof with a (second) heat-sensitive adhesive layer, the removable substrate being provided to the (second) heat-sensitive adhesive layer.

4. The improved thermo bonding film structure of claim 1, wherein the heat-sensitive adhesive is sprayed over or transfer printed to the face of the thermo bonding film.

5. The improved thermo bonding film structure of claim 1, wherein the substrate consists one selected from the group consisting of: a release layer, polyethylene (PE) and polyethylene terephthalate (PET).
